(19) United States
(12) Patent Application Publication
(10) Pub. No.: US 2026/0267954 A1
(43) Pub. Date: Sep. 10, 2026

(54) REMOTE AUTHENTICATION OF IDENTIFICATION SIGNS

(71) Applicant: AL AMRI, Eisa Moosa, Dubai (AE)

(72) Inventor: Eisa Moosa AL AMRI, Dubai (AE)

(21) Appl. No.: 19/165,322

(22) PCT Filed: Nov. 27, 2023
(86) PCT No.: PCT/IB2023/061924

§ 371 Date: Sep. 15, 2025

(30) Foreign Application Priority Data
Mar. 16, 2023 (WO) PCT/IB2023/052571

(51) Int. Cl. G06F 21/35; G06V 40/30

(52) U.S. Cl. CPC G06F 21/35; G06V 40/30

(57) ABSTRACT

An image of an identification sign (10) is transmitted from a certifying location to a remote location. At the certifying location, a Notary Public or a Consulate or any other certifying authority or person (15) provides an identification sign (10) such as a signature, fingerprint or stamp image for attesting the authenticity of an object such as a document or a person's signature. The remote location is the location of an object such as a document whose authenticity is to be certified, or of a person whose signature is to be certified. A transmission device (35) at the remote location transmits, to the certifying location, a signal (38) that requests certification and preferably identifies a document to be certified or a person (18) whose signature is to be authenticated. Communicating means such as a video camera or PC (55) transmits, in response to reception of the identification signal (38), an image of the identification sign (10) provided by the certifying person (15) or authority, to a receiving device (40) at the remote location that reproduces the identification sign (10) on a supporting document or other support (50) to attest authenticity.

### FIELD OF THE INVENTION

The invention relates to a system for transmitting identification signs from a given location to a remote location. It is particularly concerned with system arranged for authenticating, at a remote location, an object such as a document or a signature, by an identification sign produced by an authoritative person or an authority at a given location

### BACKGROUND OF THE INVENTION

Technical progress, population density, the expansion of commercial, urban, and civil activities have given rise to legal, consulting, judicial work, and other documentation activities for members of society with cultures, professions, and activities that are different and sometimes interrelated. For maintaining rights and legal positions regarding exchanged dealings, such dealings were documented. Legislative enactments often require various dealings that are exchanged amongst members of society to be written and documented. For instance, legislation may require company contracts to be authenticated before a notary public, for example partnership agreements executed by partners in a limited liability company.

Performing such work requires a mechanism for fast and accurate legal authentication of such documents. However, under present arrangements, such authentication requires personal travel to the authenticating authority, which is time consuming, and inconvenient.

This invention aims to simplify such authentication between separate partners at different locations in one or more countries while meeting legal requirements, using available technology for transmitting identification signs from a given location to a remote location.

CN10708882A describes a robot anthropomorphic handwriting writing system and a control method thereof capable of intelligently learning and imitating a user's handwriting through an App platform. Bionic printers use the original writing tools, to efficiently complete the writing. A computer obtains the user's handwriting path through the user writing on a programming platform. This enables signatures and handwriting to be copied in various scripts such as Chinese script and western script. A random algorithm is coordinated via random fields. The handwriting of the person according to the user's identification is exported to the writing system, replacing the operating user to complete writing using the device. This is an Axidraw device that can be used for transferring signatures to a remote location.

US published patent application 2011/0060985A1 describes a system and method for collecting a signature using a smart device. This system enables a signature to be placed on a document viewed on smart phone A signature module allows a user to input a signature via the smart device display with a pixel size larger than the pixel size of the smart device by causing a viewable portion of a signature file to scroll relative to the display while the user is inputting the signature. After a signature has been captured, a document viewer module executing on the smart device allows a user to appropriately position and size the signature for placement on a document being viewed on a smart device.

These prior art devices can be appropriately modified for transmitting an image of an identification sign such as a signature from a given location to a remote location. For example, a signature is sent to a typewriter so that the signature can be executed on a document.

### SUMMARY OF THE INVENTION

The system according to the invention is designed for authenticating an object such as a document or a signature, by an identification sign produced by a certifying person or an authority at an authorizing location, without a need for a person whose signature is to be authenticated to travel to the location of the authorizing person.

For this purpose, the invention provides a system for transmitting an image of an identification sign from a given location to a remote location, which system comprises:
at a given location: a first support such as a screen configured to receive an image of an identification sign and a first transmission device for transmission of the image of the identification sign, and at a remote location: a receiving device configured to receive the transmitted image of the identification sign from the first transmission device, and to reproduce the image of the identification sign on a second support such as a document or others.

The system according to the invention is characterized in that the system is arranged for authenticating, at the remote location, an object such as a document or a signature, by an identification sign produced by a certifying person or an authority at the given location.

For this, the given location is the location of a certifying person or of a certifying authority that is adapted to provide an identification sign for attesting the authenticity of a document or a person's signature and identity. The remote location is the location of an object such as a document whose authenticity is to be certified or the location of a person whose signature on a document is to be certified.

The system according to the invention comprises communicating means comprising cooperating emitting and receiving devices at the authorizing location and the remote location, for example video cameras or PCs, and optionally smart phones for communicating the given location with the remote location. A second transmission device at the remote location is arranged to transmit from the remote location to the given location a signal that requests authentication of and preferably identifies an object at the remote location. In one example, the second transmission device transmits, via a video camera of the communicating means, a signal that requests both authentication of an object at the remote location and also identifies an object at the remote location. In another example, when a person at the remote location or his signature is to be authenticated, a signal requesting authentication of the person or his signature can be transmitted by smartphone whereas a signal identifying the person or his signature can be transmitted by video camera.

The communicating means is arranged to transmit, in response to reception at the given location of the signal that requests authentication of an object, for example a request signal transmitted to the given location by smartphone, an image of the identification sign of the certifying person or authority from the given location to the receiving device at the remote location. This signal of the image of the identification sign of the certifying person or authority can be transmitted for example by video camera from the given location directly to the remote location, or can be transmitted by video camera from the given location to an intermediate server that downloads the image of the identification sign to the remote location.

Moreover, the receiving device at the remote location is operable to reproduce the identification sign on a supporting document at the remote location that is associated with the object to be authenticated, to thereby attest the authenticity of the object such a document or the authenticity of a person's signature.

In many embodiments of the invention, the identification sign is a signature. Alternatively, the identification sign is for example a fingerprint or a stamp image.

The certifying person is typically a Notary Public or an officer of a Consulate or other person who is able to make certifications.

When the identification sign is for example a signature produced by a certifying person's writing or drawing instrument such as a pen, the receiving device at the remote location comprises a holder configured for holding the writing or drawing instrument and for reproducing identification sign.

Alternatively, when the identification sign is for example a stamp or a fingerprint, the receiving device at the remote location can comprise a printer for reproducing the identification sign such as a stamp image or a fingerprint.

The means for communicating the given location with the remote location conveniently comprises is a video camera or PC at the given location and/or at the remote location coupled with a video receiver or PC at the at the given location and/or at the remote location.

The support associated with the object at the remote location to be authenticated typically bears a distinctive sign such as the signature or fingerprint of a person for authentication. For example, the support associated with the object at the remote location is a document bearing the signature of a person to be authenticated

A further aspect of the invention is a first transmission device located at the given location of a system as defined above, arranged for transmission of an image of a certifying sign produced by a certifying person or an authority at the given location, and wherein the first transmission device is arranged to receive a signal that that requests authentication of an object at the remote location; and to transmit, in response to reception of the signal that requests authentication of an object at the remote location, the image of the certifying sign sign to the remote location.

Yet another aspect of the invention is a receiving device located at the remote location of a system according to the invention, the receiving device being configured: to produce at the remote location a signal that requests authentication of an object at the remote location, to transmit the signal that requests authentication of an object at the remote location, from the remote location to a given location of the system, and to authenticate the object at the remote location in response to transmission of the signal to the given location of the system by the receiving device.

This receiving device is for example adapted to receive the image of an identification sign produced by a certifying person or an authority at the given location in response to receipt at the given location of the signal that requests authentication, and to reproduce the image of the identification sign on a second support associated with the object to be authenticated to attest the authenticity of the object.

The invention also concerns a method for transmitting an image of an identification sign from a given location to a remote location by a system according to the invention for authenticating an object at the remote location by an identification sign produced by a certifying person (15) or an authority at the given location, the method comprising:
producing on a first support at the given location, an identification sign of a certifying person,
transmitting, from the remote location to the given location, a signal requesting authentication of and identifying an object at the remote location,
transmitting, from the given location to the the remote location, in response to reception at the given location of the signal requesting authentication of an object, an image of the identification sign, and
reproducing the identification sign on a support at the remote location associated with the object to be authenticated, to attest the authenticity of the object.

### BRIEF DESCRIPTION OF FIGURES

The invention will be further described with reference to the accompanying schematic Figures, in which:

FIG. 1 is a schematic diagram of a system according to the invention.

FIG. 2 is a perspective view of receiving device holding a pen for reproducing the identification sign such as a signature or text at the remote location.

FIG. 3 is a perspective view of an alternative type of receiving device comprising a stamp printer for reproducing the identification sign such as a stamp image or a fingerprint at the remote location.

FIG. 4 shows a signature device, it is a smart device along with a pen to be placed at the given or certifying location for applying a signature on the screen of the smart device, and two views of a smart device forming a support to be placed at the remote location for receiving an authenticating signature.

### DETAILED DESCRIPTION

The invention provides a system for transmitting an image of an identification sign 10 from a given or authenticating location to a remote location. The system is designed for authenticating, at the remote location, an object such as a document 45 or a signature, by an identification sign 10 produced by an authoritative or certifying person 15 or an authority at the remote authentication location.

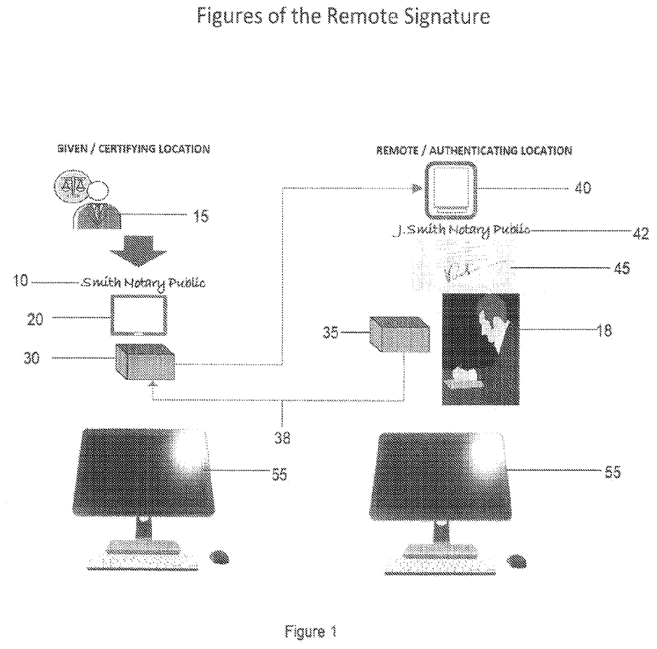

Briefly, at the certifying location, a Notary Public 15 or an official from a Consulate provides an identification sign 10 such as a signature, fingerprint or stamp image for attesting the authenticity of a document or a person's signature. The identification sign 10 illustrated in FIG. 1 is “J. Smith Notary Public”, but it could simply be a signature such as “John Smith” alone or with a stamp such as a Notary Public's stamp, or a fingerprint of the certifying person 15.

The remote location is the location of an object such as a document whose authenticity is to be certified, and/or is the location of a person 18 whose signature is to be certified.

A transmission device 35 at the remote location transmits, to the certifying location, a signal 38 that requests authentication of and identifies an object such as a document to be certified or a person 18 whose signature is to be authenticated. This signal 38 can be obtained for example from a video image of the person 18 and/or for example by scanning the person 18's passport or another identification document. The signal 38 to request authentication can also be transmitted by smartphone.

Cooperating video cameras/receivers or other means of communication such as personal computers 55 place the certifying location in communication with the remote location, for transmission of the authentication request signal 38 that preferably also identifies the object to be authenticated. The video camera/video receiver or other means of communication 55 at the certifying location, serve as a transmission device 30 that transmits, to a receiving device 40 at the remote location, in response to reception by the transmission device 30 of the authentication request signal 38 sent from the remote location, an image of the identification sign 10 that was provided by the certifying person 15 or authority at the certifying location.

This receiving device 40 at the remote location then reproduces the identification sign 10 on a document 45 associated with the object to be authenticated. This document 45 constitutes a second support at the remote location to attest authenticity of the person's signature.

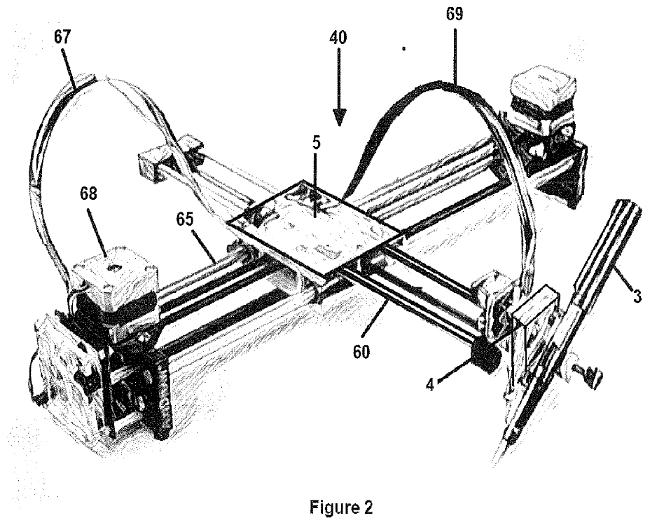

When the identification sign 10 is a signature produced by a pen held in the certifying person 15's hand, the receiving device 40 at the remote location comprises a penholder 4 holding a pen 3 configured for reproducing the signature. FIG. 2 is a perspective view of an example of a known type of such a receiving device 40 with a pen 3 held in a mobile support at the end of an arm of a mobile frame 5, operable to duplicate a signature in response to the signal received from the transmission device 30.

When the identification sign 10 is a stamp or a fingerprint, the receiving device 40 can comprise a printer for reproducing the identification sign 10 such as a stamp image or a fingerprint.

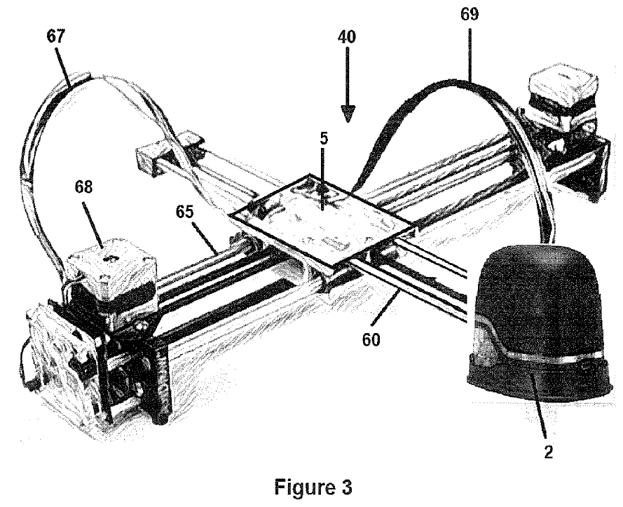

FIG. 3 shows an alternative type of receiving device comprising a mini printer 2 for reproducing the identification sign 10 such as a stamp image or a fingerprint.

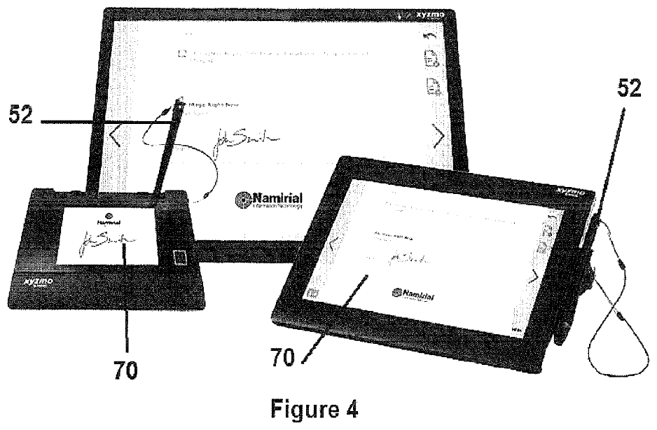

FIG. 4 shows a support-forming smart device 40 along with a pen 3 to be placed at the given or certifying location, for applying a signature such as “John Smith” of the certifying person on the screen of the smart device 40.

FIG. 4 also shows two views of a smart device 70 (also with an attached smart pen 52) forming a support to be placed at the remote location for receiving an authenticating signature 10 such as “JohnSmith” applied at a given authenticating location on a document presented on the screen of the smart device 70.

Any smart device 70 where the certifying person can sign on the screen using a smart pen 52 or typewriter pen device can be used, so that the signature or other authenticating sign is sent via a program or an application through wired and/or wireless communication networks by the communicating means 55. The executor's signature is thus transferred to sign and authenticate an instrument or document 45 that must be signed by the relevant parties of a contract, or stakeholders, located at a remote location in one country or in different locations over the globe. This is achieved through a virtual transmission of the signature executed on the smartphone screens, via a program and/or an application transmitting the executor's signature applied for example by a pen that can be held in the certifying person's device.

The receiving device 40 of FIG. 2 has many known features like a pen drawer/slide which is of a simple robot type whose function is to direct the pen 3 (or any other tool fixed in the pen holder, such as a stamp printer 2) installed in the pen holder, or any other identification tool that reproduces the identification sign 10 of the person authenticating the transaction. The identification signal 38 can be a face print, a handprint, or a one-time password (OTP) that provides at least one reliable identification and defines the vector lines, curves, and paths for the pen 3 at the remote certification location to follow. The function of this system/machine is to make drawings, write a text or sign a document, or other requirements for certification/authentication. It is a versatile system/machine that caters for various categories of needs of the persons 45 whose signature for example is to be authenticated. The system/device enables use of any suitable pen 3 to write or sign with. It does not require a particular pen. The user can choose any pen to sign with, in terms of color, size and other features.

FIG. 3 shows an alternative type of receiving device comprising a stamp printer 2 fixed in the pen holder for reproducing the identification sign 10 such as a stamp image or a fingerprint. This device also has many features to direct the stamp printer 2 installed in the pen holder at the remote authenticating location according to a signal that indicates the requester of the transaction, such as a stamp print or a handprint. The function of this machine is to make drawings, write a text or sign a document, or other requirements.

### Overview of Functioning of in the Invention

The certifying person 15 sends a command consecutively or alternatively of the certifying sign 10 to users at remote locations. i.e. people carrying smartphones, computers, laptops, or any other smart devices that execute the certifying sign such as signature using a pen or other device to download the signature or stamp at the remote location via a specialized device on documents and/or instruments that are adapted to download the signature or stamp thereon. It is thereby certified that the signature was initially made and sent by the certifying person and received at the remote location for example with a receiver using the pen or the stamp printer. The certifying signature initially made for example by a Notary Public's by pen is transmitted to a “signature executor” such as a pen at a remote geographical location, sent for example through WWW via a specialized program and/or application to the “signature executor” comprising for example a pen.

1.-13. (canceled)

14. A system for transmitting an image of an identification sign from a given location to a remote location, the System comprising:
at the given location:
a first support such as a screen configured to receive an image of an identification sign and a first transmission device for transmission of the image of the identification sign, and at the remote location:
a receiving device configured to receive the transmitted image of the identification sign from the first transmission device, and to reproduce the image of the identification sign on a second support,
wherein
the system is arranged such that the given location is the location of a certifying person or of a certifying authority that is adapted to provide an identification sign for certifying the authenticity of an object such as a document, and the remote location is the location of an object such as a document whose authenticity is to be certified, and wherein:
the system according to the invention comprises means for communicating the given location with the remote location,
a second transmission device at the remote location is arranged to transmit from the remote location to the given location, a signal that requests authentication of an object at the remote location;
the communicating means is arranged to transmit, in response to reception at the given location of the signal that requests authentication of an object at the remote location, an image of the identification sign of the certifying person or authority from the given location to the receiving device at the remote location, and
the receiving device at the remote location is operable to reproduce the identification sign on a support at the remote location, which support is associated with the object to be authenticated, to certify the authenticity of the object.

15. A system according to claim 14, wherein the identification sign is a signature, a fingerprint or a stamp image.

16. A system according to claim 14, wherein the certifying person is a Notary Public, or an officer of a Consulate or any other certifying authority or person with authority to make certifications.

17. A system according to claim 14, wherein the identification sign is for example a signature produced by a writing or drawing instrument such as a pen, and the receiving device at the remote location comprises a holder configured for holding the writing or drawing instrument and for reproducing identification sign.

18. A system according to claim 14, wherein the identification sign is a stamp or a fingerprint, and the receiving device at the remote location comprises a printer for reproducing an image of the stamp or fingerprint.

19. A system according to claim 14, wherein said means for communicating the remote location with the given location comprises co-operating emission and reception devices at the given location and the remote location, for example a video camera at the given location and/or at the remote location, coupled with a video receiver at the given location and/or at the remote location, or a personal computer at the given location and/or at the remote location, coupled with a personal computer at the given location and/or at the remote location, and optionally a smartphone at the given location and the remote location.

20. A system according to claim 14, wherein the support associated with the object at the remote location to be authenticated bears a distinctive sign such as the signature or fingerprint of a person for authentication.

21. A system according to claim 20, wherein the support associated with the object at the remote location is a document bearing the signature of a person to be authenticated.

22. A first transmission device located at the given location of a system as defined in claim 14, arranged for transmission of an image of a certifying sign produced by a certifying person or an authority at the given location, and wherein the first transmission device is arranged:
to receive a signal that that requests authentication of an object at the remote location; and
to transmit, in response to reception of the signal that requests authentication of an object at the remote location, the image of the certifying sign sign to remote location.

23. A receiving device located at the remote location of a system according to claim 14, the receiving device being configured:
to produce at the remote location a signal that requests authentication of an object at the remote location,
to transmit the signal that requests authentication of an object at the remote location, from the remote location to a given location of the system, and
to authenticate the object at the remote location in response to transmission of the signal to the given location of the system by the receiving device.

24. The receiving device of claim 23 which is adapted to receive the image of an identification sign produced by a certifying person or an authority at the given location in response to receipt at the given location of the signal, and to reproduce the image of the identification sign on a second support associated with the object to be authenticated to attest the authenticity of the object.

25. A method for transmitting an image of an identification sign from a given location to a remote location by a system according to the invention for authenticating an object at the remote location by an identification sign produced by a certifying person or an authority at the given location, the method comprising:
producing on a first support at the given location, an identification sign of a certifying person,
transmitting, from the remote location to the given location, a signal requesting authentication of an object at the remote location,
transmitting, from the given location to the the remote location, in response to reception of the signal at the given location, an image of the identification sign, and
reproducing the identification sign on a support at the remote location associated with the object to be authenticated, to attest the authenticity of the object.
